(19) United States
(12) Patent Application Publication
(10) Pub. No.: US 2009/0184468 A1
(43) Pub. Date: Jul. 23, 2009

(54) Electrical chess module

(75) Inventor: Hsien-Jung Huang, Taipei County (TW)

Correspondence Address: WPAT, PC, 7225 BEVERLY ST., ANNANDALE, VA, 22003, US

(73) Assignee: Hsien-Jung Huang, Taipei County (TW)

(21) Appl. No.: 12/015,700

(22) Filed: Jan. 17, 2008

(51) Int. Cl. A63F 3/02; H02J 17/00

(52) U.S. Cl. 273/237; 307/17

(57) ABSTRACT

An electrical chess module is disclosed. A LED and a first coil are configured at every chessman, and the LED and the first coil are parallel connection. A electric power and a second coil are configured at the chessboard, wherein the second coil makes the electromagnetic induction due to a magnetic field resulted from the electric current of the electric power, thereby the luminous apparatus of every chessman will shine because the first coil produces a electric current due to the electromagnetic induction between the first coil and the magnetic field.

### BACKGROUND OF THE INVENTION

1. Field of the Invention

The present invention generally relates to chess module, and more particularly to electrical chess module.

2. Description of the Prior Art

The most of chesses comprise a plurality of chessmen and a chessboard. The traditional chesses are always unexciting because the chessmen are invariably lightless.

If every chessman has a battery for shining, the volume of the chessman must be too large to play, and too many batteries will be another problem. These problems bother chess player very much.

### SUMMARY OF THE INVENTION

Therefore, in accordance with the previous summary, objects, features and advantages of the present disclosure will become apparent to one skilled in the art from the subsequent description and the appended claims taken in conjunction with the accompanying drawings.

An electrical chessman is disclosed. The electrical chessman comprises at least one luminous apparatus and a coil module comprising a metal pillar and a coil, wound around the metal pillar, wherein two ends of the coil are separately a first terminal and a second terminal. When the coil module comes into contact with a magnetic field, the coil module applies a electric current due to electromagnetic induction, and the coil module applies electric current via the first terminal and the second terminal. Every luminous apparatus comprises a first electrode and a second electrode, and the first and second electrodes are separately electrically connected to the first terminal and the second terminal, thereby the luminous apparatus receives electric current to shine.

An electrical chess module is also disclosed. The chess module comprises at least one chessman and a chessboard. Every Chessman comprises at least one luminous apparatus and a first coil module comprising a first metal pillar and a first coil, wound around the metal pillar, wherein one end of the first coil is a first terminal, and the other end of said first coil is a second terminal. Every luminous apparatus comprises a first electrode and a second electrode, and the first and second electrodes are separately electrically connected to the first terminal and the second terminal. In addition, the chessboard comprises a second coil module and a periodic circuit. The second coil module comprises at least one second coil, wherein one end of the second coil is a third terminal and a fourth terminal, and electromagnetic induction is resulted from every second coil receiving a first electric current via the third terminal and the fourth terminal separately. The periodic circuit comprises a third electrode and a fourth electrode, wherein the third electrode is electrically connected to every third terminal, and the fourth electrode is electrically connected to every fourth terminal, wherein the periodic circuit periodically outputs the first electric current according to a preset period via the third electrode and the fourth electrode.

### BRIEF DESCRIPTION OF THE DRAWINGS

The accompanying drawings incorporated in and forming a part of the specification illustrate several aspects of the present invention, and together with the description serve to explain the principles of the disclosure. In the drawings:

FIG. 1 is a diagram illustrates chessman;

FIG. 2 is a diagram depicts light source;

FIG. 3 and FIG. 4 are diagrams illustrates electrical chess module; and

FIG. 5 is a diagram shows the circuit of the coil module of the chessboard.

### DETAILED DESCRIPTION OF THE PREFERRED EMBODIMENTS

The present disclosure can be described by the embodiments given below. It is understood, however, that the embodiments below are not necessarily limitations to the present disclosure, but are used to a typical implementation of the invention.

Having summarized various aspects of the present invention, reference will now be made in detail to the description of the invention as illustrated in the drawings. While the invention will be described in connection with these drawings, there is no intent to limit it to the embodiment or embodiments disclosed therein. On the contrary the intent is to cover all alternatives, modifications and equivalents included within the spirit and scope of the invention as defined by the appended claims.

It is noted that the drawings presents herein have been provided to illustrate certain features and aspects of embodiments of the invention. It will be appreciated from the description provided herein that a variety of alternative embodiments and implementations may be realized, consistent with the scope and spirit of the present invention.

It is also noted that the drawings presents herein are not consistent with the same scale. Some scales of some components are not proportional to the scales of other components in order to provide comprehensive descriptions and emphasizes to this present invention.

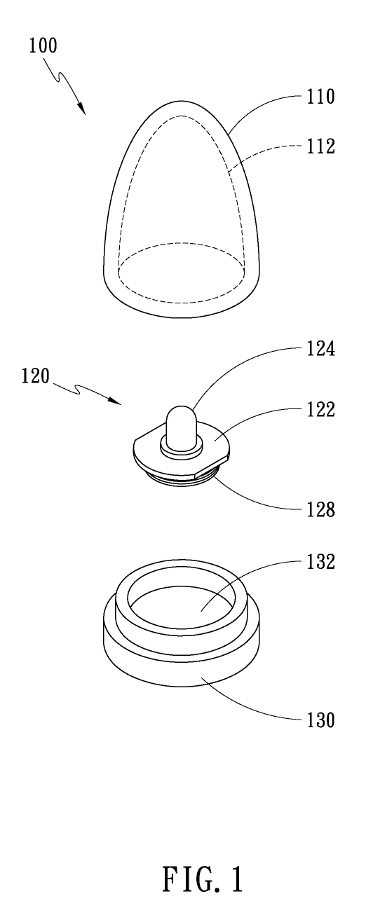

FIG. 1 illustrates an electrical chessman 100, comprising a case and an illuminant 120, wherein the illuminant 120 is disposed inside the case. In an embodiment of this invention, the case could comprise a top cover 110 and a base 130, wherein a first space is provided at the inner peripheral 112 of the top cover, and the base 130 could comprise a salient 132, and the salient 132 surrounds a second space on the base 130, thereby the illuminant 120 is wrapped in the first and second space.

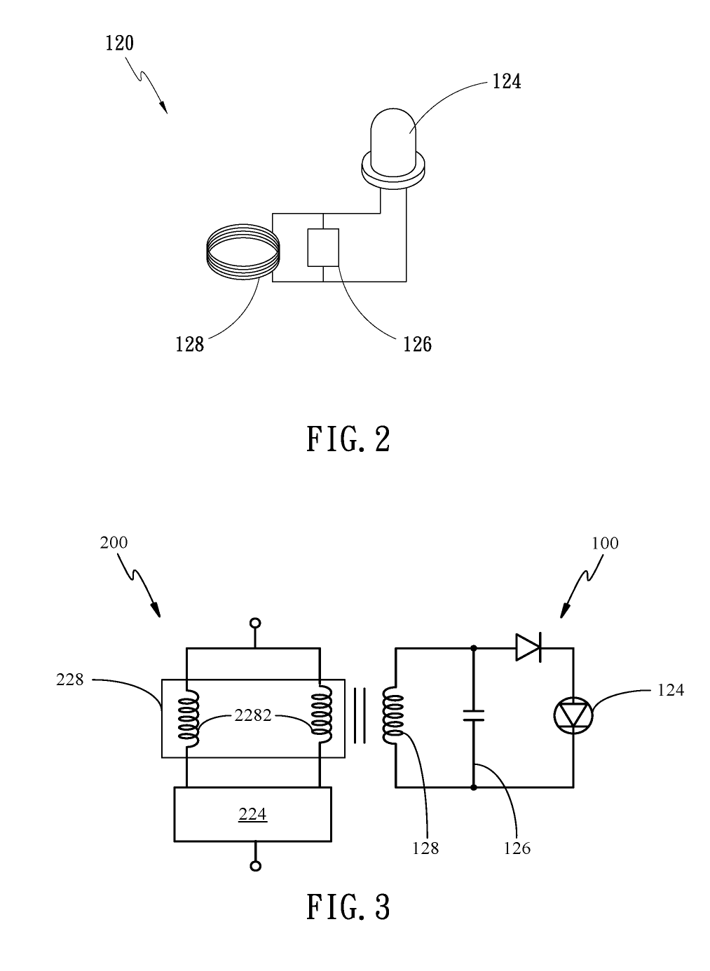

FIG. 2 illustrates the illuminant 120 of the electrical chessman. In an embodiment of this invention, the illuminant 120 comprises a coil module 128 and at least one luminous apparatus 124, as shown in FIG. 2. The coil module 128 comprises a metal pillar and a coil, wherein the coil is wound around the metal pillar, and two ends of the coil are separately a first terminal and a second terminal. When a magnetic field is occurred around the coil module 128, the coil module 128 outputs an electric current via the first terminal and the second terminal due to electromagnetic induction. In another embodiment of this invention, the coil module 128 could comprise only a coil without the metal pillar.

Besides, every luminous apparatus 124 comprises a first electrode and a second electrode, wherein the first electrode is electrically connected to the first terminal, and the second electrode is electrically connected to the second terminal, thereby the luminous apparatus 124 receives the electric current to shine. In this embodiment, the luminous apparatus 124 further comprises an electric capacity 126, comprising the first terminal and the second terminal. In other words, the electric capacity is parallel connected with the coil 128 and the luminous apparatus 124. Furthermore, the first electrode and the second electrode of every luminous apparatus 124 could be separately parallel connected with the electric capacity.

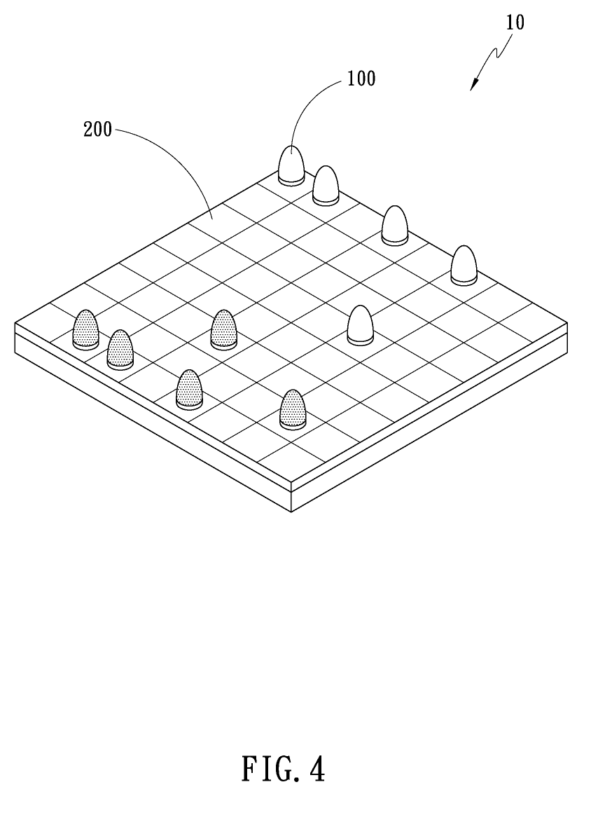

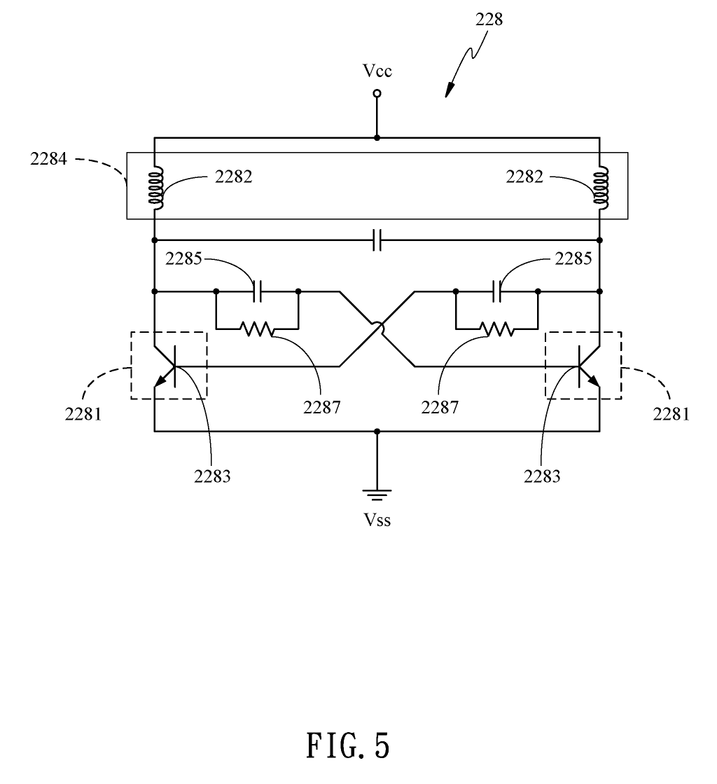

In view of the above, another embodiment of this invention is an electrical chess 10, as shown in FIG. 3 and FIG. 4. The electrical chess 10 comprises at least one chessman 100 and a chessboard 200.

Please refer to FIG. 2, the chessman 100 comprises a coil module 128 (namely a first coil module in this embodiment) and at least one luminous apparatus 124. There is only one luminous apparatus 124, as shown in FIG. 2, but this invention is not limited in only one luminous apparatus 124. The first coil module 128 comprises a metal pillar (namely a first metal pillar) and a coil (namely a first coil), wherein the first coil is wound around the metal pillar, and both ends of the first coil are separately a first terminal and a second terminal, wherein the first coil module 128 contacts a magnetic field, the first coil module 128 produces an electric current due to electromagnetic induction, and the first module 128 supplies the electric current via the first terminal and the second terminal. In an embodiment of this invention, the first coil module 128 could comprise a coil without the metal pillar.

Besides, every luminous apparatus 124 comprises a first electrode and a second electrode, wherein the first electrode is electrically connected to the first terminal, and the second electrode is electrically connected to the second terminal, thereby the luminous apparatus 124 receives the electric current to shine. The luminous apparatus 124 further comprises a electric capacity 126, comprising the first terminal and the second terminal. On the other words, the electric capacity 126 is parallel connected with the first coil 128 and luminous apparatus 124. In this embodiment, the electric capacity 126 could be parallel connected with the first coil 128 and luminous apparatus 124, separately.

FIG. 3 illustrates the chessboard 200 comprising a second coil module 228 and a periodic circuit 224.

The second coil module 228 comprises at least a second coil 2282, wherein both ends of every second coil 2282 are separately a third terminal and a fourth terminal, and every second coil 2282 receives the first electric current to make electromagnetic induction via the third terminal and the fourth terminal. The amount of the second coils 2282 are not limited, even though there are two second coils 2282 in FIG. 3.

The periodic circuit 224 comprises a third electrode and a fourth electrode, and the third and fourth electrode are separately electrically connected to every third terminal and every fourth terminal, wherein the periodic circuit 224 supplies the first electric current according to a preset period via the third electrode and the fourth electrode.

In another embodiment of this invention, the second coil module 228 comprises at least one second metal pillar, and every second coil 2282 is wound around one of the second metal pillars. In another embodiment of this invention, the second coil module 228 could comprise only one coil without metal pillar. In addition, every first coil forms a second electric current (or the electric current) due to electromagnetic induction, and every first coil applies the second electric current via the first terminal and the second terminal, wherein every luminous apparatus receives the second electric current to shine. In another embodiment of this invention, the luminous apparatus could be a LED (Light Emitting Diode), a light bulb, a fluorescent tube or any apparatus which could shines due to electric power. In this embodiment, every second coil 2282 could comprise a electric capacity, comprising the third terminal and the fourth terminal. Or the second coil module 228 comprises a electric capacity, comprising the third terminal and the fourth terminal.

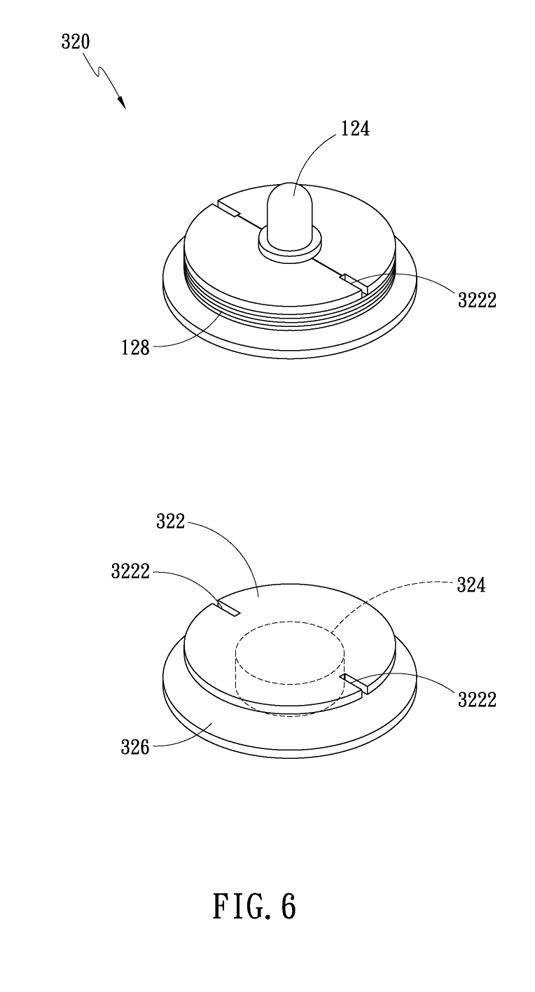

FIG. 5 shows another embodiment for the second coil module 228. The second module 228 could comprise at least one pair second coils 2284, and each of every pair second coils 2284 comprises a control circuit 2281, comprising a switch 2283, wherein the third terminal of every second coil is electrically connected to the third electrode via the control circuit 2281, and the switch 2283 of the control circuit 2281 of one of every pair of the second coils 2284 is electrically connected to the third terminal of the other one of the second coils. A electric capacity 2285 and a resistance 2287 between every switch 2283 and the third terminal electrically connected to the switch 2283, and the switch 2283 is electrically connected to the third terminal via the parallel connection of the electric capacity 2285 and the resistance 2287.

In addition, every pair of the second coils 2284 further comprises a electric capacity 2286, wherein both ends of the electric capacity 2286 are separately electrically connected to the third terminal of every second coil 2282 of the pair of the second coils 2284.

The light source could be illustrated as FIG. 6. The light source 320 comprises a coil frame 322, a coil module 128 and at least one luminous apparatus 124. The coil frame 322 comprises a top plate 322, a center pillar 324 and a bottom plate 326. Two ditches are located at the top plate 322, and the center pillar 324 comprises a top and a bottom, wherein the top and the bottom are separately connected with the center of the top plate 322 and the bottom plate 326. The coil module 128 comprises a coil wound around the center pillar 324, and two ends of the coil are separately a first terminal and a second terminal, wherein the first terminal and the second terminal separately pass through one of two ditches to protrude outside the top plate. When the coil module 128 comes into contact with a magnetic field, the coil module 128 makes the electromagnetic induction due to the magnetic field to apply the electric current, and the coil module 128 applies the electric current via the first and second terminal. Besides, every luminous apparatus 124 is located at the top plate 322, and the luminous apparatus 124 comprises a first electrode and a second electrode, wherein the first electrode and the second are separately electrically connected with the first terminal and the second terminal, thereby the luminous apparatus 124 receives the electric current to shine.

The foregoing description is not intended to be exhaustive or to limit the invention to the precise forms disclosed. Obvious modifications or variations are possible in light of the above teachings. In this regard, the embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the inventions as determined by the appended claims when interpreted in accordance with the breath to which they are fairly and legally entitled.

It is understood that several modifications, changes, and substitutions are intended in the foregoing disclosure and in some instances some features of the invention will be employed without a corresponding use of other features. Accordingly, it is appropriate that the appended claims be construed broadly and in a manner consistent with the scope of the invention.

1. An electrical chess module, comprising:
at least one chessman, wherein every chessman comprising:
a first coil module comprising at least one first coil, wherein one end of said first coil is a first terminal, and the other end of said first coil is a second terminal; and
at least one luminous apparatus, wherein every luminous apparatus comprises a first electrode electrically, connected to every first terminal, and a second electrode, electrically connected to every second terminal; and
a chessboard, comprising:
a second coil module comprising at least one second coil, wherein one end of said second coil is a third terminal and a fourth terminal, wherein electromagnetic induction is resulted from every second coil receiving a first electric current via said third terminal and said fourth terminal separately; and
a periodic circuit comprising a third electrode and a fourth electrode, wherein said third electrode is electrically connected to every third terminal, and said fourth electrode is electrically connected to every fourth terminal, wherein said periodic circuit periodically outputs said first electric current according to a preset period via said third electrode and said fourth electrode.

2. An electrical chess module of claim 1, wherein every chessman further comprises an electric capacity comprising said first terminal and said second terminal.

3. An electrical chess module of claim 1, wherein every luminous apparatus further comprises an electric capacity comprising said first terminal and said second terminal.

4. An electrical chess module of claim 1, wherein said second coil module comprises at least one second metal pillar, and every second coil is separately wound around one second metal pillar.

5. An electrical chess module of claim 1, wherein every first coil outputs a second electric current due to electromagnetic induction, and said second electric current is outputted via said first terminal and said second terminal.

6. An electrical chess module of claim 5, wherein said luminous apparatus receives said second electric current to shine.

7. An electrical chess module of claim 1, wherein said luminous apparatus is a LED (Light Emitting Diode).

8. An electrical chess module of claim 1, wherein every second coil further comprises an electric capacity comprising said third terminal and said fourth terminal.

9. An electrical chess module of claim 1, wherein said second coil module further comprises a electric capacity comprising said third terminal and said fourth terminal.

10. An electrical chess module of claim 1, wherein said second coil module comprises at least one pair of second coils, and every one of every pair of second coils comprises a control circuit comprising a switch, wherein said third terminal of said second coil is electrically connected to said electrode via said control circuit, and said switch of said control circuit of one second coil of every pair of second coils is electrically connected to said third terminal of the other second coil.

11. An electrical chess module of claim 10, wherein every pair of second coils further comprises a electric capacity, and both ends of said electric capacity are separately electrically connected to said third terminal of every second coil of said pair of second coils.

12. An electrical chess module of claim 10, further comprising a electric capacity and a resistance between said switch and said third terminal electrically connected to said switch, said switch is electrically connected to said third terminal via the parallel circuit between said electric capacity and said resistance.

13. An electrical chess module of claim 10, wherein every chessman further comprises a case wrapping said first coil module and said at least one luminous apparatus.

14. An electrical chess module of claim 10, wherein said first coil module further comprises a first metal pillar, and said first coil is wound around said first metal pillar.

15. An electrical chessman, comprising:
a coil module comprising a coil, and both ends of said coil are separately a first terminal and a second terminal, wherein said coil module outputs a electric current due to electromagnetic induction when a magnetic field is set around said coil, and said coil module outputs said electric current via said first terminal and said second terminal; and
at least one luminous apparatus, wherein every luminous apparatus comprises a first electrode and a second electrode, wherein said first electrode and said second electrode are separately electrically connected to said first terminal and said second terminal, wherein said luminous apparatus receives said electric current to shine.

16. An electrical chessman of claim 15, further comprising an electrical capacity comprising said first terminal and said second terminal.

17. An electrical chessman of claim 15, wherein every luminous apparatus further comprises a electric capacity, and said electric capacity comprises said first terminal and said second terminal.

18. An electrical chessman, comprising:
a coil frame, comprising:
a top plate comprising two ditches;
a center pillar comprising a top and a bottom, wherein said top is connected with the center of said top plate; and
a bottom plate, wherein said bottom is connected with the center of said bottom plate;
a coil module comprising a coil wound around said center pillar, and both ends of said coil are separately a first terminal and a second terminal, passing through one of said two ditches to protrude outside said top plate, wherein when said coil module contacts a magnetic field, said coil module outputs a electric current due to electromagnetic induction between said coil module and said magnetic field, and said coil outputs said electric current via said first terminal and said second terminal; and
at least one luminous apparatus, wherein every luminous apparatus is located on said top plate and comprises a first electrode and a second electrode, wherein said first electrode and said second electrode are separately electrically connected to said first terminal and said second terminal, and said luminous apparatus receives said electric current to shine.

19. An electrical chess module, comprising:
at least one chessman, wherein every chessman comprises:
a coil frame, comprising:
a top plate, wherein two ditches are located at said top plate;
a center pillar comprising a top and a bottom, wherein said top is connected with the center of said top plate; and
a bottom plate, wherein said bottom is connected with the center of said bottom plate;
a first coil module comprising at least one first coil wound around said center pillar, and both ends of said first coil are separately a first terminal and a second terminal, passing through one of said two ditches to protrude outside said top plate; and;
at least one luminous apparatus, wherein every luminous apparatus is located on said top plate and comprises a first electrode and a second electrode, wherein said first electrode and said second electrode are separately electrically connected to said first terminal and said second terminal; and
a chessboard, comprising:
a second coil module comprising at least one second coil, wherein both ends of every second coil are separately a third terminal and a fourth terminal, and every second coil receives a first electric current via said third terminal and said fourth terminal to cause electromagnetic induction; and
a periodic circuit comprising a third electrode and a fourth electrode, wherein said third electrode is electrically connected to every third terminal, and said fourth electrode is electrically connected to every fourth terminal, wherein said periodic circuit periodically outputs said first electric current according to a preset period via said third electrode and said fourth electrode.
